(19) United States
(12) Patent Application Publication
(10) Pub. No.: US 2020/0075975 A1
(43) Pub. Date: Mar. 5, 2020

(54) FUEL CELL VEHICLE

(71) Applicant: TOYOTA JIDOSHA KABUSHIKI KAISHA, Toyota-shi (JP)

(72) Inventor: Kunihiko Toyofuku, Toyota-shi (JP)

(73) Assignee: TOYOTA JIDOSHA KABUSHIKI KAISHA, Toyota-shi (JP)

(21) Appl. No.: 16/456,729

(22) Filed: Jun. 28, 2019

(30) Foreign Application Priority Data
Aug. 29, 2018 (JP) 2018-159887

(51) Int. Cl. H01M 8/04223; H01M 8/04082; H01M 8/04007

(52) U.S. Cl. CPC H01M 8/04253; H01M 2250/20; H01M 8/04007; H01M 8/04201

(57) ABSTRACT

A fuel cell vehicle includes: a fuel cell; a water storage tank; a spray nozzle connected to the water storage tank via water supply pipes and opposed to a to-be-cleaned object; a first pump configured to send the fuel-cell generated water in the water storage tank to the spray nozzle via the water supply pipes; and at least one electronic control unit configured to determine, based on an operating condition and an outside air temperature of the fuel cell vehicle, whether there is a possibility that the fuel-cell generated water inside the water storage tank and the water supply pipes will freeze within a predetermined time and cause the first pump to operate to spray the fuel-cell generated water from the spray nozzle to the to-be-cleaned object when it is determined that there is no possibility that the fuel-cell generated water will freeze within the predetermined time.

### INCORPORATION BY REFERENCE

The disclosure of Japanese Patent Application No. 2018-159887 filed on Aug. 29, 2018 including the specification, drawings and abstract is incorporated herein by reference in its entirety.

### BACKGROUND

### 1. Technical Field

The present disclosure relates to a fuel cell vehicle.

### 2. Description of Related Art

Japanese Patent Application Publication No. 2005-108529 (JP 2005-108529 A) discloses a fuel cell vehicle (sometimes referred to as an FC vehicle in the description below). The FC vehicle includes a fuel cell that generates electricity by chemical reaction between hydrogen and oxygen and an electric motor that is the driving source of the vehicle operating with the use of electric power generated by the fuel cell.

The FC vehicle further includes a washer fluid tank connected to a spray nozzle and a pump that generates a pressure for delivering a washer fluid in the washer fluid tank to the spray nozzle. Therefore, when an occupant operates the pump operation switch (cleaning switch) provided in the interior of the vehicle, the washer fluid in the washer fluid tank is sprayed from the spray nozzle to the outside by a pressure generated by the pump. Then, the washer fluid is sprayed onto a to-be-cleaned object (for example, a window) provided on the vehicle in such a way that it is opposed to the spray nozzle and, as a result, the to-be-cleaned object is cleaned with the washer fluid.

The FC vehicle further includes a water storage tank that temporarily stores generated water generated during the power generation of the fuel cell. This water storage tank is connected to the washer fluid tank via a tank connection pipe.

When the amount of washer fluid in the washer fluid tank becomes equal to or less than a predetermined amount, the valve provided in the tank connection pipe is opened to supply the fuel-cell generated water, stored in the water storage tank, to the washer fluid tank. In addition, after the fuel-cell generated water is supplied to the washer fluid tank, a concentrated washer fluid is supplied to the washer fluid tank to maintain the concentration of the washer fluid within a predetermined range. In this way, according to the technique disclosed in Japanese Patent Application Publication No. 2005-108529 (JP 2005-108529 A), the generated water generated by the fuel cell is effectively used as a washer fluid.

### SUMMARY

According to the technique described in Japanese Patent Application Publication No. 2005-108529 (JP 2005-108529 A), when the amount of the washer fluid in the washer fluid tank is larger than the predetermined amount, the valve is closed and the fuel-cell generated water is drained through the drainage path, provided in the tank connection pipe, to the outside of the vehicle. Therefore, from the viewpoint of the effective use of fuel-cell generated water, there is room for improvement in the technique described in Japanese Patent Application Publication No. 2005-108529 (JP 2005-108529 A).

The present disclosure provides a fuel cell vehicle that can effectively use generated water generated by the fuel cell.

A first aspect of the disclosure provides a fuel cell vehicle. The fuel cell vehicle includes: a fuel cell configured to generate electric power to be supplied to an electric motor by chemical reaction between hydrogen and oxygen, the electric motor generating a driving force for rotating driving wheels; a water storage tank that stores fuel-cell generated water generated during power generation of the fuel cell; a spray nozzle connected to the water storage tank via water supply pipes and opposed to a to-be-cleaned object provided on a part of the fuel cell vehicle; a first pump configured to send the fuel-cell generated water in the water storage tank to the spray nozzle via the water supply pipes; and at least one electronic control unit configured to determine, based on an operating condition and an outside air temperature of the fuel cell vehicle, whether there is a possibility that the fuel-cell generated water inside the water storage tank and the water supply pipes will freeze within a predetermined time and cause the first pump to operate to spray the fuel-cell generated water from the spray nozzle to the to-be-cleaned object when it is determined that there is no possibility that the fuel-cell generated water will freeze within the predetermined time.

According to the above configuration, when the freezing determination unit determines that there is no possibility that the fuel-cell generated water will freeze within the predetermined time, the fuel-cell generated water is sprayed from the spray nozzle to the to-be-cleaned object. Therefore, according to the present embodiments, the fuel-cell generated water can be used more effectively than in the conventional configuration.

In the first aspect, the fuel cell vehicle may include: a washer fluid tank that can be filled with a washer fluid and can supply the washer fluid to the spray nozzle via a washer fluid pipe connected to the water supply pipes and via the water supply pipes, the washer fluid being a mixture of water and a cleaning fluid; and a tank connection pipe that connects the water storage tank and the washer fluid tank, wherein the first pump may be configured to send the fuel-cell generated water in the water storage tank to the tank connection pipe, and the at least one electronic control unit may be configured to determine, based on the operating condition and the outside air temperature, whether there is a possibility that the fuel-cell generated water in the tank connection pipe will freeze within the predetermined time and cause the first pump to operate to supply the fuel-cell generated water in the tank connection pipe to the washer fluid tank when it is determined that there is the possibility that the fuel-cell generated water in the tank connection pipe will freeze within the predetermined time.

According to the above configuration, when the freezing determination unit determines that there is a possibility that the fuel-cell generated water in the tank connection pipe will freeze within the predetermined time, the fuel-cell generated water in the tank connection pipe is supplied to the washer fluid tank. Therefore, the fuel-cell generated water can be used not only as a washing means for cleaning a to-be-cleaned object but also as the washer fluid. Therefore, the fuel-cell generated water can be used more effectively.

In the first aspect, the fuel cell vehicle may include a cleaning fluid replenishment device configured to supply the cleaning fluid to the washer fluid tank such that a concentration of the washer fluid becomes equal to or higher than a predetermined threshold concentration, when the concentration of the washer fluid becomes lower than the predetermined threshold concentration by supplying the fuel-cell generated water in the tank connection pipe to the washer fluid tank.

According to the above configuration, when the fuel-cell generated water in the tank connection pipe is supplied to the washer fluid tank, the concentration of the washer fluid in the washer fluid tank can be kept equal to or higher than the threshold concentration.

In the first aspect, the fuel cell vehicle may include a second pump configured to send the washer fluid in the washer fluid tank to the spray nozzle via the washer fluid pipe and the water supply pipes, wherein the at least one electronic control unit may be configured to cause the second pump to operate to fill the washer fluid pipe and an area of the water supply pipes between the washer fluid tank and the spray nozzle with the washer fluid when it is determined that there is a possibility that the fuel-cell generated water in the water supply pipes will freeze within the predetermined time.

According to the above configuration, when the freezing determination unit determines that there is a possibility that the fuel-cell generated water in the water supply pipes will freeze, the washer fluid pipe and an area of the water supply pipes between the washer fluid tank and the spray nozzle are filled with the washer fluid. Since the washer fluid is a mixture of water and a cleaning fluid, its freezing point is lower than that of the fuel-cell generated water. Therefore, when this area is filled with the washer fluid, the possibility that the water present in this area will freeze decreases. Therefore, when the second pump is subsequently operated, the possibility that the washer fluid cannot be sprayed from the spray nozzle to the outside decreases.

In the first aspect, the fuel cell vehicle may include a fuel-cell generated water drain unit connected to the water supply pipes and capable of draining the fuel-cell generated water to an outside of the fuel cell vehicle, wherein the at least one electronic control unit may be configured to cause the first pump to operate to drain the fuel-cell generated water in the water supply pipes through the fuel-cell generated water drain unit when it is determined that there is a possibility that the fuel-cell generated water in the water supply pipes will freeze within the predetermined time.

According to the above configuration, when the freezing determination unit determines that there is a possibility that the fuel-cell generated water in the water supply pipes will freeze, the fuel-cell generated water in the water supply pipes is drained to the outside through the fuel-cell generated water drain unit. Therefore, there is no possibility that the fuel-cell generated water will freeze inside the water supply pipes and the fuel-cell generated water drain unit.

In the first aspect, the fuel cell vehicle may include: a washer fluid tank that can be filled with a washer fluid and can supply the washer fluid to the spray nozzle via a washer fluid pipe connected to the water supply pipes and via the water supply pipes, the washer fluid being a mixture of water and a cleaning fluid; and a tank connection pipe that connects the water storage tank and the washer fluid tank, wherein the first pump may be configured to send the fuel-cell generated water in the water storage tank to the tank connection pipe, and the at least one electronic control unit may be configured to determine, based on the operating condition and the outside air temperature, whether there is a possibility that the fuel-cell generated water in the tank connection pipe will freeze within the predetermined time, cause the first pump to operate to supply the fuel-cell generated water in the tank connection pipe to the washer fluid tank when it is determined that there is the possibility that the fuel-cell generated water in the tank connection pipe will freeze within the predetermined time and when the washer fluid tank satisfies a predetermined replenishment requirement, and cause the first pump to operate to drain the fuel-cell generated water in the water supply pipes through a fuel-cell generated water drain unit connected to the water supply pipes and capable of draining the fuel-cell generated water to the outside of the fuel cell vehicle when it is determined that there is a possibility that the fuel-cell generated water in the water supply pipes will freeze within the predetermined time and when the washer fluid tank does not satisfy the predetermined replenishment requirement.

In the first aspect, the at least one electronic control unit may be configured to cause the first pump to operate to supply the fuel-cell generated water in the tank connection pipe to the washer fluid tank when it is determined that there is the possibility that the fuel-cell generated water in the tank connection pipe will freeze within the predetermined time and when the washer fluid tank satisfies a predetermined replenishment requirement, and cause the first pump to operate to drain the fuel-cell generated water in the water supply pipes through a fuel-cell generated water drain unit connected to the water supply pipes and capable of draining the fuel-cell generated water to the outside of the fuel cell vehicle when it is determined that there is a possibility that the fuel-cell generated water in the water supply pipes will freeze within the predetermined time and when the washer fluid tank does not satisfy the predetermined replenishment requirement.

According to the above configuration, only when the fuel-cell generated water in the tank connection pipe is not supplied to the washer fluid tank, the fuel-cell generated water in the water supply pipes can be drained to the outside through the fuel-cell generated water drain unit.

A second aspect of the disclosure provides a fuel cell vehicle. The fuel cell vehicle includes: a fuel cell; a water storage tank that stores fuel-cell generated water generated during power generation of the fuel cell; a spray nozzle connected to the water storage tank via water supply pipes and opposed to a to-be-cleaned object provided on a part of the fuel cell vehicle; a first pump configured to send the fuel-cell generated water in the water storage tank to the spray nozzle via the water supply pipes; and at least one electronic control unit configured to cause the first pump to operate to spray the fuel-cell generated water from the spray nozzle to the to-be-cleaned object when an ignition switch is ON.

In the second aspect, the fuel cell vehicle may further include: a washer fluid tank that can be filled with a washer fluid and can supply the washer fluid to the spray nozzle via a washer fluid pipe connected to the water supply pipes and via the water supply pipes, the washer fluid being a mixture of water and a cleaning fluid; and a tank connection pipe that connects the water storage tank and the washer fluid tank, wherein the first pump may be configured to send the fuel-cell generated water in the water storage tank to the tank connection pipe, and the at least one electronic control unit may be configured to cause the first pump to operate to supply the fuel-cell generated water in the tank connection pipe to the washer fluid tank when the ignition switch is OFF and an outside air temperature of the fuel cell vehicle is equal to or lower than a predetermined value.

In the second aspect, the fuel cell vehicle may further include: a second pump configured to send the washer fluid in the washer fluid tank to the spray nozzle via the washer fluid pipe and the water supply pipes, wherein the at least one electronic control unit may be configured to cause the second pump to operate to fill the washer fluid pipe and an area of the water supply pipes between the washer fluid tank and the spray nozzle with the washer fluid when the ignition switch is OFF and the outside air temperature of the fuel cell vehicle is equal to or lower than the predetermined value.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic block diagram showing a fuel cell and a cleaning system of a fuel cell vehicle according to an embodiment of the present disclosure;

FIG. 2 is a flowchart showing the processing performed by a cleaning control ECU according to the embodiment of the present disclosure; and

FIG. 3 is a flowchart showing the processing performed by a cleaning control ECU according to a modification of the present disclosure.

### DETAILED DESCRIPTION OF EMBODIMENTS

An FC vehicle according to an embodiment of the present disclosure will be described in detail below with reference to the drawings.

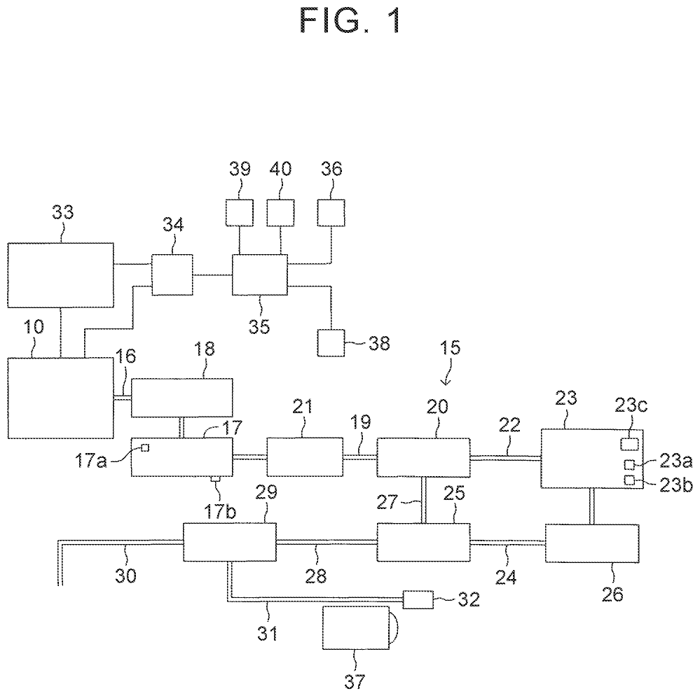

The FC vehicle in this embodiment includes an electric motor (not shown) that is the drive source of driving wheels and a fuel cell 10 (shown in FIG. 1) that generates electric power to be supplied to the electric motor. As is commonly known, the fuel cell 10 includes a fuel cell stack, configured by stacking a plurality of single cells, for generating electric power by reaction between hydrogen and oxygen as will be described later.

As shown in FIG. 1, a cleaning system 15 is connected to the fuel cell 10. The cleaning system 15 includes a tank water supply pipe 16, a water storage tank 17, a water recovery unit 18, a first tank connection pipe 19, a first switching valve 20, a first pump 21, a second tank connection pipe 22, a washer fluid tank 23, a washer fluid pipe 24, a second switching valve 25, a second pump 26, a bypass pipe 27, a common pipe 28, a third switching valve 29, a drain pipe 30, a spray pipe 31, and a spray nozzle 32.

The fuel cell 10 is connected to the water storage tank 17 via the tank water supply pipe 16. In addition, on the tank water supply pipe 16, the water recovery unit 18 located between the fuel cell 10 and the water storage tank 17 is provided.

A water level sensor 17a for detecting the amount (water level) of fuel-cell generated water in the water storage tank 17 is provided inside the water storage tank 17. In addition, a hole (not shown) is formed at the bottom of the water storage tank 17 with a plug 17b removably plugging this hole. When an occupant does not operate the water drain switch (not shown) provided in the interior of the vehicle, the plug 17b closes the hole of the water storage tank 17. On the other hand, when the occupant operates the water drain switch, the plug 17b opens the hole of the water storage tank 17. This drain switch and the plug 17b is operated manually without using electric power. Furthermore, on the upper part of the water storage tank 17, an overflow drain hole (not shown) is provided. When the fuel-cell generated water is supplied from the tank water supply pipe 16 to the water storage tank 17 with the water storage tank 17 completely filled with the fuel-cell generated water, the fuel-cell generated water in the water storage tank 17 is drained to the outside through the overflow drain hole.

The water storage tank 17 is connected to the electrically operated first switching valve 20 via the first tank connection pipe 19. In addition, the electrically-operated first pump 21, located between the water storage tank 17 and the first switching valve 20, is provided on the first tank connection pipe 19. When the first pump 21 is in the stopped state (that is, in the non-operating state), the movement of the fuel-cell generated water in the water storage tank 17 to the first switching valve 20 side is prohibited by the first pump 21.

In addition, the washer fluid tank 23, into which the washer fluid is stored, is connected to the first switching valve 20 via the second tank connection pipe 22. A water level sensor 23a for detecting the amount (water level) of the washer fluid in the washer fluid tank 23 and a concentration sensor 23b for detecting the concentration of the washer fluid are provided in the washer fluid tank 23. The washer fluid is a mixed fluid of a concentrated washer fluid and water, and the concentrated washer fluid is a cleaning fluid containing alcohol. Therefore, the freezing point of the washer fluid is much lower than the freezing point (0° C.) of water (for example, −30° C. or lower). In addition, a concentrated washer fluid replenishment device 23c is provided inside the washer fluid tank 23. This concentrated washer fluid replenishment device 23c, which has a tank for storing a concentrated washer fluid, can supply the concentrated washer fluid into the washer fluid tank 23. It is possible to replenish a concentrated washer fluid from the outside of the vehicle into the tank of the concentrated washer fluid replenishment device 23c via a fluid inlet (not shown) provided on the washer fluid tank 23.

The electrically operated second switching valve 25 is connected to the washer fluid tank 23 via the washer fluid pipe 24. The electrically operated second pump 26, located between the washer fluid tank 23 and the second switching valve 25, is provided on the washer fluid pipe 24. When the second pump 26 is in the stopped state (that is, in the non-operating state), the movement of the washer fluid in the washer fluid tank 23 to the second switching valve 25 side is prohibited by the second pump 26.

The first switching valve 20 and the second switching valve 25 are connected to each other by the bypass pipe 27. A check valve (not shown) that prohibits the flow of the fluid from the second switching valve 25 side to the first switching valve 20 side is provided on the bypass pipe 27. In addition, the second switching valve 25 is connected to the electrically operated third switching valve 29 via the common pipe 28.

One end of the drain pipe 30 is connected to the third switching valve 29. The other end of the drain pipe 30 opens to the outside of the FC vehicle.

In addition, one end of the spray pipe 31 is connected to the third switching valve 29, and the spray nozzle 32 is provided on the other end of the spray pipe 31. The spray nozzle 32 does not spray the supplied fluid (that is, the fuel-cell generated water and the washer fluid) when the pressure of the fluid, supplied via the spray pipe 31, is equal to or lower than the predetermined pressure value; on the other hand, spray nozzle 32 sprays the supplied fluid to the outside when the pressure of the supplied fluid is higher than the predetermined pressure value. In this embodiment, the spray nozzle 32 is provided on the rear surface of a back door (not shown) provided at the rear of the FC vehicle.

The first switching valve 20 can be switched between a first state and a second state. In the first state, the first switching valve 20 allows a flow of the fluid between the first tank connection pipe 19 and the bypass pipe 27 and prohibits a flow of the fluid between the first tank connection pipe 19 and the second tank connection pipe 22 and a flow of the fluid between the second tank connection pipe 22 and the bypass pipe 27. On the other hand, in the second state, the first switching valve 20 allows a flow of the fluid between the first tank connection pipe 19 and the second tank connection pipe 22 and prohibits a flow of the fluid between the first tank connection pipe 19 and the bypass pipe 27 and a flow of the fluid between the second tank connection pipe 22 and the bypass pipe 27.

The second switching valve 25 can be switched between a first state and a second state. In the first state, the second switching valve 25 allows a flow of the fluid between the bypass pipe 27 and the common pipe 28 and prohibits a flow of the fluid between the bypass pipe 27 and the washer fluid pipe 24 and a flow of the fluid between the common pipe 28 and the washer fluid pipe 24. On the other hand, in the second state, the second switching valve 25 allows a flow of the fluid between the common pipe 28 and the washer fluid pipe 24 and prohibits a flow of the fluid between the bypass pipe 27 and the washer fluid pipe 24 and a flow of the fluid between the bypass pipe 27 and the common pipe 28.

The third switching valve 29 can be switched between a first state and a second state. In the first state, the third switching valve 29 allows a flow of the fluid between the common pipe 28 and the spray pipe 31 and prohibits a flow of the fluid between the common pipe 28 and the drain pipe 30 and a flow of the fluid between the drain pipe 30 and the spray pipe 31. On the other hand, in the second state, the third switching valve 29 allows a flow of the fluid between the common pipe 28 and the drain pipe 30 and prohibits a flow of the fluid between the common pipe 28 and the spray pipe 31 and a flow of the fluid between the drain pipe 30 and the spray pipe 31.

As shown in FIG. 1, a secondary battery 33 is connected to the fuel cell 10. In addition, the fuel cell 10 and the secondary battery 33 are connected to a cleaning control ECU 35 (hereinafter referred to as an ECU 35) via a driving circuit 34. The ECU, an abbreviation of Electric Control Unit, includes a microcomputer that includes a CPU and storage devices such as a ROM and a RAM. The CPU implements various functions by executing instructions (programs) stored in the ROM. The driving circuit 34 includes a timer circuit. To the ECU 35, an ignition switch 36 (hereinafter referred to as IG⋅SW 36), the water level sensor 17a, water level sensor 23a, and concentration sensor 23b are connected. The driving circuit 34 is connected to the concentrated washer fluid replenishment device 23c, first switching valve 20, first pump 21, second switching valve 25, second pump 26, and third switching valve 29.

A camera 37 is provided on the rear surface of the back door in such a way that it is opposed to the spray nozzle 32. In addition, a temperature sensor 38 for detecting the outside air temperature of the FC vehicle is provided on a part of the vehicle body (for example, on the front grill). The camera 37 is connected to the driving circuit 34, and the temperature sensor 38 is connected to the ECU 35.

In addition, a fuel-cell generated water spray switch 39 and a washer fluid spray switch 40 are provided in the interior of the FC vehicle. The fuel-cell generated water spray switch 39 and the washer fluid spray switch 40 are connected to the ECU 35.

Next, the operation of the fuel cell 10, cleaning system 15, camera 37, and temperature sensor 38 will be described.

When the IG⋅SW 36 is switched from OFF to ON, the electric power stored in the secondary battery 33 is supplied to the electric motor to start it. Since the power of the secondary battery 33 is supplied to the camera 37 via the driving circuit 34, the camera 37 repeats the capturing operation until the IG⋅SW 36 is switched to OFF. In addition, the water level sensor 17a, water level sensor 23a, concentration sensor 23b, and temperature sensor 38 repeatedly send their detection values to the ECU 35 until the IG⋅SW 36 is switched to OFF. Note that, when the IG⋅SW 36 is switched from OFF to ON, the washer fluid tank 23 is already filled with a predetermined amount of washer fluid. The washer fluid is a mixture of a concentrated washer fluid (cleaning fluid), supplied from the concentrated washer fluid replenishment device 23c, and water. On the other hand, at this point, there is no fuel-cell generated water inside the water storage tank 17 with the hole plugged by the plug 17b.

In addition, when the IG⋅SW 36 is switched to ON, hydrogen is supplied from a hydrogen tank (not shown), which is provided in the interior of the vehicle, to the fuel cell 10. At the same time, air (oxygen) outside the FC vehicle is supplied from the intake port (not shown), provided at the front end of the FC vehicle, to the fuel cell 10 via an air supply path (not shown). Then, in the fuel cell 10, hydrogen and oxygen react with each other to generate electric power and, when electric power is generated, water (hereinafter referred to as fuel-cell generated water) is generated. The fuel-cell generated water generated by the fuel cell 10 is hot to some extent (for example, about 60° C.). At this time, when a predetermined condition is satisfied after the fuel cell 10 has generated electric power, the electric power, not stored in the secondary battery 33 but generated by the fuel cell 10, is supplied to the electric motor. The electric power generated by the fuel cell 10 in this way is also stored in the secondary battery 33 as necessary.

The fuel-cell generated water generated by the fuel cell 10 is supplied to the water recovery unit 18 via the tank water supply pipe 16. The water recovery unit 18 is connected to a humidifier (not shown), and a part of the fuel-cell generated water, supplied to the water recovery unit 18, is supplied to the humidifier. The humidifier is connected to the above-described air supply path, with the result that the air in the air supply path is humidified by the fuel-cell generated water supplied to the humidifier.

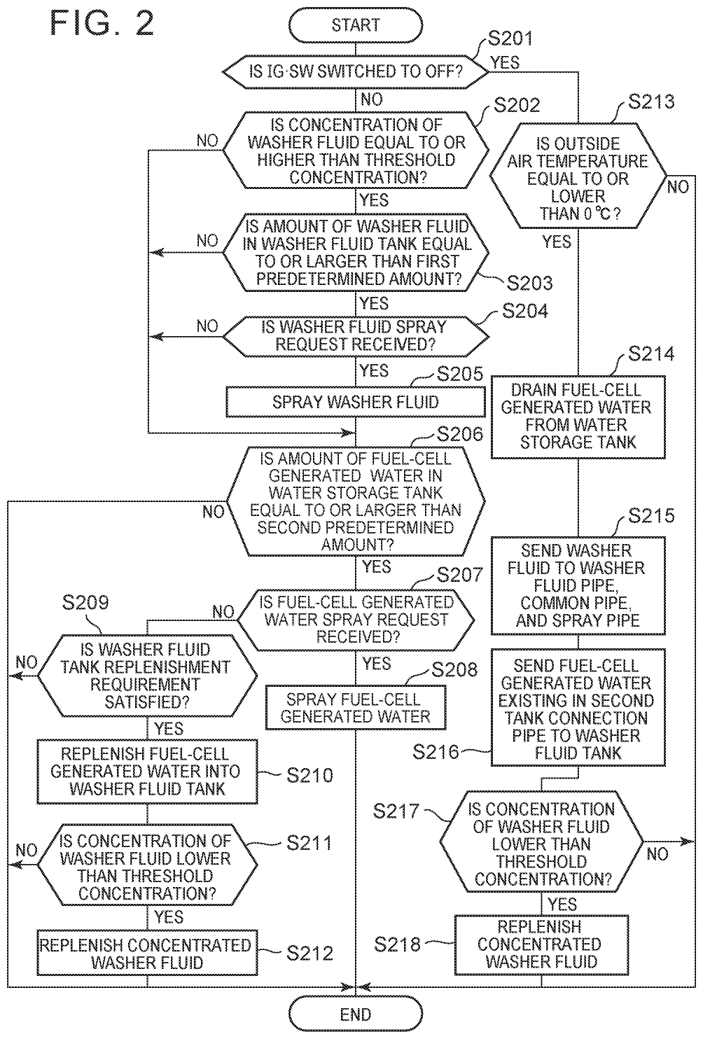

The fuel-cell generated water that is supplied not to the humidifier but to the water recovery unit 18 is supplied to the water storage tank 17 via the tank water supply pipe 16. When the IG⋅SW 36 is switched to ON, the fuel-cell generated water generated by the fuel cell 10 is continuously supplied to the water storage tank 17 in this way. This causes the water level (amount of water) of the fuel-cell generated water in the water storage tank 17 to rise. The fuel-cell generated water stored in the water storage tank 17 is used for various purposes as will be described later. The use of the fuel-cell generated water is determined by the ECU 35 based on the operating condition and the outside air temperature of the FC vehicle. That is, when the IG⋅SW 36 is switched from OFF to ON, the ECU 35 repeatedly performs the processing of the flowchart shown in FIG. 2 each time a predetermined time elapses. The processing of the flowchart in FIG. 2, performed by the ECU 35, will be described below.

Note that, when the IG⋅SW 36 is switched from OFF to ON, the first switching valve 20, second switching valve 25, and third switching valve 29 all enter the first state.

First, in step S201, the ECU 35 determines whether the IG⋅SW 36 is switched from ON to OFF.

When it is determined by the ECU 35 that the result of step S201 is No, the hot fuel-cell generated water, generated by the fuel cell 10, is continuously supplied to the water storage tank 17. In this case, the hot fuel-cell generated water is supplied from the water storage tank 17 to each part of the cleaning system 15 as will be described later. Therefore, in this case, there is no possibility that the fuel-cell generated water will freeze in any part of the cleaning system 15.

When it is determined that the result of step S201 is No, the processing of the ECU 35 proceeds to step S202. In step S202, it is determined whether the concentration of the washer fluid detected by the concentration sensor 23b is equal to or higher than a predetermined threshold concentration. The information on the threshold concentration is recorded in the storage device of the ECU 35. Since the washer fluid is a mixed fluid of a concentrated washer fluid, which is a cleaning fluid containing alcohol, and water, the concentration of the washer fluid is a value calculated by dividing the amount of the cleaning fluid in the washer fluid tank 23 by the amount of the washer fluid in the washer fluid tank 23. The threshold concentration is a concentration at which, when the concentration of the washer fluid becomes lower than the threshold concentration, the cleaning ability of the washer fluid sprayed from the spray nozzle 32 is substantially reduced. In the above description of the threshold concentration, it is assumed that the washer fluid in the washer fluid tank 23 is supplied to the common pipe 28 and the spray pipe 31 via the washer fluid pipe 24 with the common pipe 28 and the spray pipe 31 filled only with fuel-cell generated water.

When it is determined that the result of step S202 is Yes, the processing of the ECU 35 proceeds to step S203. In step S203, the ECU 35 determines whether the amount of washer fluid in the washer fluid tank 23 is equal to or larger than a first predetermined amount based on the detection value of the water level sensor 23a. When the amount of washer fluid is equal to or larger than the first predetermined amount, the washer fluid pipe 24, common pipe 28, and spray pipe 31 can be filled with the washer fluid flowing from the washer fluid tank 23 when the second pump 26 is operated, the second switching valve 25 is in the second state, and the third switching valve 29 is in the first state. In this case, the total amount of washer fluid with which the washer fluid pipe 24, the common pipe 28, and the spray pipe 31 are filled is referred to as a first total amount.

When it is determined that the result of step S203 is Yes, the processing of the ECU 35 proceeds to step S204. In step S204, the ECU 35 determines whether a washer fluid spray request is received. That is, the ECU 35 determines whether the occupant has pressed the washer fluid spray switch 40.

When it is determined that the result of step S204 is Yes, the processing of the ECU 35 proceeds to step S205. In step S205, the ECU 35 sends the power of the secondary battery 33 to the second switching valve 25 as an activation signal for a first predetermined time via the driving circuit 34 to switch the second switching valve 25 to the second state. In addition, the ECU 35 sends the power of the secondary battery 33 to the second pump 26 as an activation signal via the driving circuit 34 for the first predetermined time. Then, this activation signal causes the second pump 26 to generate pressure to fill the inside of the washer fluid pipe 24, the common pipe 28, and the spray pipe 31 with the washer fluid, with the result that the pressure of the washer fluid becomes larger than the predetermined pressure value. Thus, a fraction of the first total amount of washer fluid is sprayed from the spray nozzle 32 to the camera 37.

When the first predetermined time has elapsed, the second pump 26 stops and the second switching valve 25 returns to the first state.

After the processing in step S205 is finished, the processing of the ECU 35 proceeds to step S206. In step S206, the ECU 35 determines whether the amount of fuel-cell generated water in the water storage tank 17 is equal to or larger than a second predetermined amount based on the detection value of the water level sensor 17a. When the amount of fuel-cell generated water is equal to or larger than the second predetermined amount, when the first switching valve 20, second switching valve 25, and third switching valve 29 are all in the first state and, at the same time, when the first pump 21 is activated, the first tank connection pipe 19, bypass pipe 27, common pipe 28, and spray pipe 31 can be filled with the fuel-cell generated water flowing from the water storage tank 17. These pipes may function as water supply pipes. In this case, the total amount of fuel-cell generated water with which the first tank connection pipe 19, bypass pipe 27, common pipe 28, and spray pipe 31 are filled is referred to as a second total amount.

When it is determined that the result of step S206 is Yes, the processing of the ECU 35 proceeds to step S207. In step S207, the ECU 35 determines whether a fuel-cell generated water spray request is received. That is, the ECU 35 determines whether the occupant has pressed the fuel-cell generated water spray switch 39.

When it is determined that the result of step S207 is Yes, the processing of the ECU 35 proceeds to step S208. In step S208, the ECU 35 sends the power of the secondary battery 33 to the first pump 21 as an activation signal for a second predetermined time via the driving circuit 34. Then, this activation signal causes the first pump 21 to generate pressure to fill the inside of the first tank connection pipe 19, the bypass pipe 27, the common pipe 28, and the spray pipe 31 with the fuel-cell generated water, with the result that the pressure of the fuel-cell generated water becomes larger than the predetermined pressure value. Thus, a fraction of the second total amount of fuel-cell generated water is sprayed from the spray nozzle 32 to the camera 37. When the second predetermined time has elapsed, the first pump 21 stops the operation.

When it is determined that the result of any of steps S202 to S204 is No, the processing of the ECU 35 proceeds directly to step S206. The ECU 35 performs the processing in steps S206 to S208.

After the processing in step S208 is finished, the ECU 35 temporarily terminates the processing of this routine.

On the other hand, when it is determined that the result of step S207 is No, the processing of the ECU 35 proceeds to step S209. In step S209, the ECU 35 determines whether a predetermined replenishment requirement is satisfied based on the detection values of the water level sensor 23a and the concentration sensor 23b. This replenishment requirement is satisfied when the amount of washer fluid detected by the water level sensor 23a is equal to or smaller than a third predetermined amount and when the concentration of washer fluid detected by the concentration sensor 23b is equal to or higher than the threshold concentration. Note that the third predetermined amount is larger than the first predetermined amount.

When it is determined in step S209 that the replenishment requirement is satisfied, the processing of the ECU 35 proceeds to step S210. In step S210, the ECU 35 sends the power of the secondary battery 33 to the first switching valve 20 and the first pump 21 as an activation signal via the driving circuit 34 for a third predetermined time. Then, for the third predetermined time, the first switching valve 20 is put in the second state and the first pump 21 starts the operation. As a result, a predetermined amount of fuel-cell generated water less than the second predetermined amount flows from the first tank connection pipe 19 to the second tank connection pipe 22 and, then, to the washer fluid tank 23. As a result, the concentration of washer fluid in the washer fluid tank 23 decreases and the amount of washer fluid increases. When the third predetermined time has elapsed, the first switching valve 20 returns to the first state and the first pump 21 stops the operation.

After the processing in step S210 is finished, the processing of the ECU 35 proceeds to step S211. In step S211, the ECU 35 determines whether the concentration of the washer fluid detected by the concentration sensor 23b is lower than the threshold concentration.

When it is determined that the result of step S211 is Yes, the processing of the ECU 35 proceeds to step S212. In step S212, the ECU 35 causes the concentrated washer fluid replenishment device 23c to operate so that the concentrated washer fluid in the tank is supplied to the washer fluid tank 23 by a predetermined amount. This predetermined amount is determined by the ECU 35 based on the detection result of the concentration sensor 23b. When the predetermined amount of concentrated washer fluid is supplied to the washer fluid tank 23, the concentration of the washer fluid detected by the concentration sensor 23b becomes equal to or higher than the threshold concentration.

After the processing in step S212 is finished, the ECU 35 temporarily terminates the processing of this routine. When it is determined that the result of any one of steps S206, S209 and S211 is No, the ECU 35 also temporarily terminates the processing of this routine.

On the other hand, when it is determined that the result of step S201 is Yes, the processing of the ECU 35 proceeds to step S213. In step S213, the ECU 35 determines whether the outside air temperature at the current time is equal to or lower than 0° C. (freezing point of water) based on the detection result of the temperature sensor 38.

When the IG⋅SW 36 is switched from ON to OFF (that is, Yes in step S201), there is a high possibility that the FC vehicle will be placed in the stopped state for a long time from the current time. Immediately after the fuel-cell generated water is generated in the fuel cell 10, its temperature is high to some extent. However, when the outside air temperature is 0° C. or lower (that is, Yes in step S213) and the FC vehicle is placed in the stopped state for a long time, the temperature of the fuel-cell generated water in the cleaning system 15 gradually decreases as the predetermined time elapses and, eventually, becomes equal to the outside air temperature over time.

Therefore, when it is assumed that the outside air temperature at the current time will be maintained over the predetermined time and when it is determined that the results of step S201 and step S213 are Yes, there is a possibility that fuel-cell generated water may freeze in any part of the cleaning system 15 while the predetermined time (for example, 6 hours) elapses from the current time. When the fuel-cell generated water has frozen, the washer fluid cannot be supplied to the spray nozzle 32 when an attempt is made later to spray the washer fluid in the washer fluid tank 23 from the spray nozzle 32. In addition, the operation of the first switching valve 20, the first pump 21, the second switching valve 25, and the third switching valve 29 is obstructed by the frozen fuel-cell generated water (ice).

When the ECU 35 determines that the result of step S213 is No, there will be no possibility that the fuel-cell generated water will freeze in any part of the cleaning system 15 while the predetermined time elapses from the current time.

Therefore, when it is determined that the result of step S213 is Yes, the processing of the ECU 35 proceeds to step S214. In step S214, the ECU 35 sends a predetermined signal to the driving circuit 34. This predetermined signal causes the driving circuit 34 to switch the state of the timer circuit to a predetermined state, thus supplying the power (activation signal) of the secondary battery 33 to the first pump 21 and the third switching valve 29 via the driving circuit 34 for a fourth predetermined time. Then, the third switching valve 29 is put in the second state for the fourth predetermined time.

In addition, when the first pump 21 operates for the fourth predetermined time, the first pump 21 can theoretically drain more fuel-cell generated water than the fuel-cell generated water existing in the tank water supply pipe 16, water storage tank 17, water recovery unit 18, first tank connection pipe 19, bypass pipe 27, common pipe 28, and drain pipe 30 from the open end of the drain pipe 30 to the outside. When IG⋅SW 36 is switched to OFF, the fuel cell 10 does not generate fuel-cell generated water. Therefore, when the ECU 35 performs the processing in step S214, the fuel-cell generated water is drained from the inside of the tank water supply pipe 16, the water storage tank 17, the water recovery unit 18, the first tank connection pipe 19, the bypass pipe 27, the common pipe 28, and the drain pipe 30. When the fourth predetermined time has elapsed, the first pump 21 stops the operation and the third switching valve 29 returns to the first state.

Even after the processing in step S214 is performed, there is a slight possibility that a small amount of fuel-cell generated water will remain at the bottom of the water storage tank 17. Therefore, after the IG⋅SW 36 is switched to OFF, the occupant of the FC vehicle may operate the water drain switch to unplug the plug 17b from the hole of the water storage tank 17 for draining the residual fuel-cell generated water to the outside of the vehicle.

After the processing in step S214 is finished, the processing of the ECU 35 proceeds to step S215. Then, the timer circuit is activated and the power of the secondary battery 33 (activation signal) is supplied to the second switching valve 25 and the second pump 26 for a fifth predetermined time. Then, for the fifth predetermined time, the second switching valve 25 is switched to the second state. In addition, for the fifth predetermined time, the second pump 26 sends the washer fluid in the washer fluid tank 23 to the washer fluid pipe 24 side to fill the washer fluid pipe 24, common pipe 28, and spray pipe 31 with the washer fluid. At this time, a predetermined amount of washer fluid is sprayed from the spray nozzle 32 toward the camera 37. When the fifth predetermined time has elapsed, the second pump 26 stops the operation and the second switching valve 25 returns to the first state. In addition, the check valve prevents the washer fluid from flowing from the common pipe 28 to the bypass pipe 27.

After the processing in step S215 is finished, the processing of the ECU 35 proceeds to step S216. Then, the timer circuit is activated and the power of the secondary battery 33 (activation signal) is supplied to the first switching valve 20 and the first pump 21 for a sixth predetermined time. Then, for the sixth predetermined time, the first switching valve 20 is put in the second state. Then, when the first pump 21 operates for the sixth predetermined time, the first pump 21 can theoretically send more fuel-cell generated water than the fuel-cell generated water existing in the second tank connection pipe 22 from the second tank connection pipe 22 to the washer fluid tank 23. Therefore, when the ECU 35 performs the processing in step S216, all the fuel-cell generated water existing in the second tank connection pipe 22 is drained to the washer fluid tank 23 when there is fuel-cell generated water inside the second tank connection pipe 22 before this processing is performed. That is, the fuel-cell generated water is completely drained from the second tank connection pipe 22. When the sixth predetermined time has elapsed, the first pump 21 stops the operation and the first switching valve 20 returns to the first state.

After the processing in step S216 is finished, the ECU 35 performs the processing in step S217. The processing in step S217 is the same as that in step S211.

When it is determined that the result of step S217 is Yes, the ECU 35 performs the processing in step S218. The processing in step S218 is the same as that in step S212.

On the other hand, when it is determined that the result of step S213 or step S217 is No, the ECU 35 temporarily terminates the processing of this routine.

As described above, when the ECU 35 determines that the results of steps S206 and S207 are Yes, the fuel-cell generated water in the water storage tank 17 is sprayed from the spray nozzle 32 to the camera 37 in this embodiment regardless of whether the washer fluid of the washer fluid tank 23 satisfies the replenishment requirement. This means that fuel-cell generated water is effectively used in this embodiment.

In addition, when the processing in steps S214 and S216 is performed, there is no possibility that the fuel-cell generated water will freeze in the cleaning system 15.

In addition, when the processing in step S215 is performed, the washer fluid pipe 24, common pipe 28, and spray pipe 31 are filled with washer fluid. The washer fluid does not freeze unless the outside air temperature becomes extremely low (for example, minus 30° C. or lower). Therefore, at a later time, even when the washer fluid spray switch 40 is operated after the IG⋅SW 36 is switched to ON again, the second switching valve 25 and the second pump 26 operate normally unless the outside air temperature becomes extremely low. Therefore, the washer fluid in the washer fluid pipe 24 is sprayed from the spray nozzle 32 to the camera 37.

Although the present disclosure has been described above based on the above embodiment, the present disclosure is not limited to the above embodiment, and various modifications are possible without departing from the object of the present disclosure.

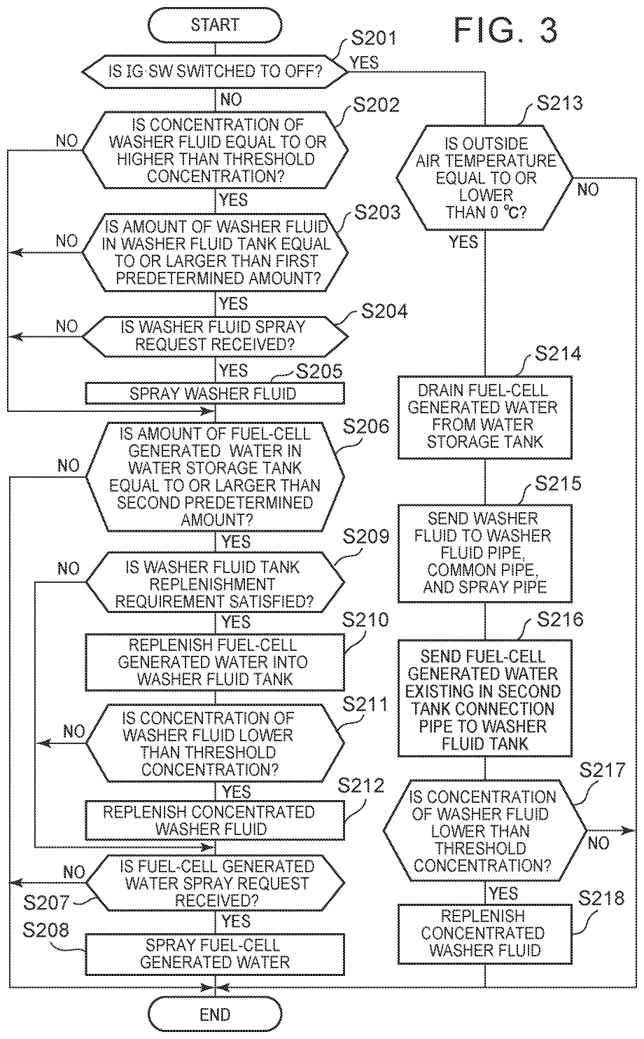

For example, the present disclosure may be implemented in the form of the modification shown in FIG. 3. In this modification, the ECU 35 performs the processing in steps S209 to S212 immediately after it is determined that the result of step S206 is Yes and, after that, performs the processing in steps S207 and S208, as shown in the flowchart in FIG. 3. Note that, when the ECU 35 performs the processing in step S210 after it is determined that the result of step S206 is Yes, the fuel-cell generated water inside the water storage tank 17 and the first tank connection pipe 19 is supplied to the washer fluid tank 23 via the second tank connection pipe 22. However, since the fuel-cell generated water in the water storage tank 17 is immediately supplied to the first tank connection pipe 19 after the processing in step S210 is completed, the inside of the first tank connection pipe 19 is filled again with the fuel-cell generated water. Therefore, when the ECU 35 performs the processing in step 208 later, an amount of fuel-cell generated water corresponding to a fraction of the second total amount is sprayed from the spray nozzle 32 to the camera 37.

In this modification, too, the ECU 35 sprays fuel-cell generated water from the spray nozzle 32 in step S208 when it is determined that the result of step S207 is Yes regardless of whether the fuel-cell generated water is replenished into the washer fluid tank 23 in steps S209 to S212. Therefore, the fuel-cell generated water is effectively used also in this modification.

An FC vehicle in the embodiment and/or the modification described above may be an automatic vehicle (AT vehicle), in which case the FC vehicle may be equipped with a shift lever position switch for detecting the position of the shift lever. When the FC vehicle is equipped with this switch, the processing in step S201 of the flowchart in FIG. 2 and/or FIG. 3 may be changed to the processing for determining “whether the shift lever position has been changed from a position other than parking (P) to parking (P)” based on the information that the ECU 35 receives from the shift lever position switch.

The camera 37 and the spray nozzle 32 may be provided at a portion other than the back door of the FC vehicle.

The FC vehicle may be equipped with a detection unit that detects a foreign matter that may adhere to the camera 37. In this case, when the detection unit detects a foreign matter, the ECU 35 may control the first pump 21, the second switching valve 25, and the second pump 26 so that the fuel-cell generated water in the water storage tank 17 or the washer fluid in the washer fluid tank 23 is sprayed automatically from the spray nozzle 32 to the camera 37.

The FC vehicle in the above embodiment and/or modification may be equipped with a spray nozzle that sprays compressed air towards the camera 37 immediately after the spray nozzle 32 sprays fuel-cell generated water and/or washer fluid towards the camera 37.

Instead of the fuel-cell generated water spray switch 39 and the washer fluid spray switch 40, one operation switch may be provided to operate the first pump 21, the second switching valve 25, and the second pump 26.

A to-be-cleaned object cleaned by fuel-cell generated water and/or washer fluid sprayed from the spray nozzle 32 is not limited to the camera 37. The to-be-cleaned object may be at least one of an infrared sensor (distance measurement sensor), a millimeter wave radar sensor, a headlight, a side mirror, and a window of the FC vehicle.

The FC vehicle may be equipped with a unit for acquiring, from an external source, the information on the weather in the area where the FC vehicle is located and its surrounding area (for example, a unit for wirelessly connecting to the Internet). In this case, based on the information on the weather, the ECU 35 estimates the outside air temperature of the FC vehicle for a predetermined time (for example, 6 hours) from the current time. When it is estimated that the outside air temperature will become 0° C. or lower while the predetermined time elapses, the ECU 35 determines that the result of step S213 is Yes and performs the processing in steps S214 to S218.

Steps S214 to S216 may be performed in any order as long as step S215 is performed after step S214. In this case too, note that steps S217 and S218 are both performed immediately after step S216.

The ECU 35 may perform the same processing as that in step S209 before the processing in step S216 and, only when the replenishment requirement is satisfied, may perform the processing in steps S216 to S218.

The ECU 35 may perform the processing in step S209 before the processing in step S216 (perform the processing in steps S216 to S218 only when it is determined that the result of step S209 is Yes) and, after the processing in steps S216, S217, and S218, may perform the processing in step S214. In this case, the ECU 35 performs the processing in step S214 only when it is determined that the result of step S209 is No.

What is claimed is:

1. A fuel cell vehicle comprising:
a fuel cell configured to generate electric power to be supplied to an electric motor by chemical reaction between hydrogen and oxygen, the electric motor generating a driving force for rotating driving wheels;
a water storage tank that stores fuel-cell generated water generated during power generation of the fuel cell;
a spray nozzle connected to the water storage tank via water supply pipes and opposed to a to-be-cleaned object provided on a part of the fuel cell vehicle;
a first pump configured to send the fuel-cell generated water in the water storage tank to the spray nozzle via the water supply pipes; and
at least one electronic control unit configured to
determine, based on an operating condition and an outside air temperature of the fuel cell vehicle, whether there is a possibility that the fuel-cell generated water inside the water storage tank and the water supply pipes will freeze within a predetermined time and
cause the first pump to operate to spray the fuel-cell generated water from the spray nozzle to the to-be-cleaned object when it is determined that there is no possibility that the fuel-cell generated water will freeze within the predetermined time.

2. The fuel cell vehicle according to claim 1, further comprising:
a washer fluid tank that can be filled with a washer fluid and can supply the washer fluid to the spray nozzle via a washer fluid pipe connected to the water supply pipes and via the water supply pipes, the washer fluid being a mixture of water and a cleaning fluid; and
a tank connection pipe that connects the water storage tank and the washer fluid tank, wherein
the first pump is configured to send the fuel-cell generated water in the water storage tank to the tank connection pipe, and
the at least one electronic control unit is configured to
determine, based on the operating condition and the outside air temperature, whether there is a possibility that the fuel-cell generated water in the tank connection pipe will freeze within the predetermined time and
cause the first pump to operate to supply the fuel-cell generated water in the tank connection pipe to the washer fluid tank when it is determined that there is the possibility that the fuel-cell generated water in the tank connection pipe will freeze within the predetermined time.

3. The fuel cell vehicle according to claim 2, further comprising
a cleaning fluid replenishment device configured to supply the cleaning fluid to the washer fluid tank such that a concentration of the washer fluid becomes equal to or higher than a predetermined threshold concentration, when the concentration of the washer fluid becomes lower than the predetermined threshold concentration by supplying the fuel-cell generated water in the tank connection pipe to the washer fluid tank.

4. The fuel cell vehicle according to claim 2, further comprising
a second pump configured to send the washer fluid in the washer fluid tank to the spray nozzle via the washer fluid pipe and the water supply pipes, wherein
the at least one electronic control unit is configured to cause the second pump to operate to fill the washer fluid pipe and an area of the water supply pipes between the washer fluid tank and the spray nozzle with the washer fluid when it is determined that there is a possibility that the fuel-cell generated water in the water supply pipes will freeze within the predetermined time.

5. The fuel cell vehicle according to claim 1, further comprising
a fuel-cell generated water drain unit connected to the water supply pipes and capable of draining the fuel-cell generated water to an outside of the fuel cell vehicle, wherein
the at least one electronic control unit is configured to cause the first pump to operate to drain the fuel-cell generated water in the water supply pipes through the fuel-cell generated water drain unit when it is determined that there is a possibility that the fuel-cell generated water in the water supply pipes will freeze within the predetermined time.

6. The fuel cell vehicle according to claim 1, further comprising:
a washer fluid tank that can be filled with a washer fluid and can supply the washer fluid to the spray nozzle via a washer fluid pipe connected to the water supply pipes and via the water supply pipes, the washer fluid being a mixture of water and a cleaning fluid; and
a tank connection pipe that connects the water storage tank and the washer fluid tank, wherein
the first pump is configured to send the fuel-cell generated water in the water storage tank to the tank connection pipe, and
the at least one electronic control unit is configured to
determine, based on the operating condition and the outside air temperature, whether there is a possibility that the fuel-cell generated water in the tank connection pipe will freeze within the predetermined time,
cause the first pump to operate to supply the fuel-cell generated water in the tank connection pipe to the washer fluid tank when it is determined that there is the possibility that the fuel-cell generated water in the tank connection pipe will freeze within the predetermined time and when the washer fluid tank satisfies a predetermined replenishment requirement, and
cause the first pump to operate to drain the fuel-cell generated water in the water supply pipes through a fuel-cell generated water drain unit connected to the water supply pipes and capable of draining the fuel-cell generated water to the outside of the fuel cell vehicle when it is determined that there is a possibility that the fuel-cell generated water in the water supply pipes will freeze within the predetermined time and when the washer fluid tank does not satisfy the predetermined replenishment requirement.

7. The fuel cell vehicle according to claim 2, wherein
the at least one electronic control unit is configured to
cause the first pump to operate to supply the fuel-cell generated water in the tank connection pipe to the washer fluid tank when it is determined that there is the possibility that the fuel-cell generated water in the tank connection pipe will freeze within the predetermined time and when the washer fluid tank satisfies a predetermined replenishment requirement, and
cause the first pump to operate to drain the fuel-cell generated water in the water supply pipes through a fuel-cell generated water drain unit connected to the water supply pipes and capable of draining the fuel-cell generated water to the outside of the fuel cell vehicle when it is determined that there is a possibility that the fuel-cell generated water in the water supply pipes will freeze within the predetermined time and when the washer fluid tank does not satisfy the predetermined replenishment requirement.

8. A fuel cell vehicle comprising:
a fuel cell;
a water storage tank that stores fuel-cell generated water generated during power generation of the fuel cell;
a spray nozzle connected to the water storage tank via water supply pipes and opposed to a to-be-cleaned object provided on a part of the fuel cell vehicle;
a first pump configured to send the fuel-cell generated water in the water storage tank to the spray nozzle via the water supply pipes; and
at least one electronic control unit configured to cause the first pump to operate to spray the fuel-cell generated water from the spray nozzle to the to-be-cleaned object when an ignition switch is ON.

9. The fuel cell vehicle according to claim 8, further comprising:
a washer fluid tank that can be filled with a washer fluid and can supply the washer fluid to the spray nozzle via a washer fluid pipe connected to the water supply pipes and via the water supply pipes, the washer fluid being a mixture of water and a cleaning fluid; and
a tank connection pipe that connects the water storage tank and the washer fluid tank, wherein
the first pump is configured to send the fuel-cell generated water in the water storage tank to the tank connection pipe, and
the at least one electronic control unit is configured to cause the first pump to operate to supply the fuel-cell generated water in the tank connection pipe to the washer fluid tank when the ignition switch is OFF and an outside air temperature of the fuel cell vehicle is equal to or lower than a predetermined value.

10. The fuel cell vehicle according to claim 9, further comprising
a second pump configured to send the washer fluid in the washer fluid tank to the spray nozzle via the washer fluid pipe and the water supply pipes, wherein
the at least one electronic control unit is configured to cause the second pump to operate to fill the washer fluid pipe and an area of the water supply pipes between the washer fluid tank and the spray nozzle with the washer fluid when the ignition switch is OFF and the outside air temperature of the fuel cell vehicle is equal to or lower than the predetermined value.
